(19) United States
(12) Patent Application Publication
(10) Pub. No.: US 2012/0315781 A1
(43) Pub. Date: Dec. 13, 2012

(54) CARD CONNECTOR WITH REAR LATCH

(75) Inventors: TERRANCE F. LITTLE, York, PA (US); AARON MICHAEL BOBUK, Bellevue, WA (US); STEPHEN SEDIO, Valley Center, CA (US)

(73) Assignee: HON HAI PRECISION INDUSTRY CO., LTD., New Taipei (TW)

(21) Appl. No.: 13/158,505

(22) Filed: Jun. 13, 2011

(51) Int. Cl. H01R 13/625

(52) U.S. Cl. 439/345

(57) ABSTRACT

A card connector (100) includes an insulative housing (2, 2′), a number of contacts (3) retained in the insulative housing, a slider (41, 41′) assembled on the insulative housing and movable relative to the insulative housing, a spring (42, 42′) compressed between the insulative housing and the slider for urging the slider along a card ejection direction, and a rear latch (231, 43) having a card lock (2312, 4312′) extending to a rear edge of an inserted card (5, 6, 5′) for securing with the rear edge of the inserted card.

### BACKGROUND OF THE INVENTION

1. Field of the Invention

The present invention relates generally to a card connector, and more particularly to a card connector which has a card lock for securing an inserted card.

2. Description of Related Arts

Micro SD (Security Digital) card standard is published by SD association. A micro SD card usually defines a side notch and a micro SD card connector is used for receiving the micro SD card. The micro SD card connector usually has an ejector comprising a slider, a spring, and a pin member for cooperatively ejecting the micro SD card. The micro SD card connector further comprises a card lock separately or integrally formed with the slider for securing with the side notch of the micro SD card. Presently, JEDEC (Joint Electronic Device Engineering Council) association is establishing a new UFS (Universal Flash Storage) card standard aiming at developing a faster memory card.

Hence, a card connector having a new card lock different from that of micro SD card connector is desired.

### SUMMARY OF THE INVENTION

Accordingly, an object of the present invention is to provide a card connector having a new card lock.

To achieve the above object, a card connector includes an insulative housing, a number of contacts retained in the insulative housing, a slider assembled on the insulative housing and movable relative to the insulative housing, a spring compressed between the insulative housing and the slider for urging the slider along a card ejection direction, and a rear latch having a card lock extending to a rear edge of an inserted card for securing with the rear edge of the inserted card.

Other objects, advantages and novel features of the invention will become more apparent from the following detailed description when taken in conjunction with the accompanying drawings.

### BRIEF DESCRIPTION OF THE DRAWINGS

FIG. 1 is a perspective, assembled view of a card connector constructed in accordance with the present invention in a first embodiment;

FIG. 2 is a perspective, exploded view of the card connector;

FIG. 3 is another perspective, exploded view of the card connector;

FIG. 4 is a first top plan view of the card connector when a top cover is removed and a UFS card is initially inserted therein;

FIG. 5 is a second top plan view of the card connector when the UFS card is fully inserted;

FIG. 6 is a third top plan view of the card connector when the top cover is removed and a micro SD card is initially inserted therein;

FIG. 7 is a fourth top plan view of the card connector when the micro SD card is fully inserted;

FIG. 8 is a cross-sectional view of the card connector when the UFS/micro SD card is not inserted;

FIG. 9 is another cross-sectional view of the card connector when the UFS/micro SD card is fully inserted;

FIGS. 10-13 are top plan views of a card connector constructed in accordance with the present invention in a second embodiment during a UFS card's insertion; and

FIGS. 14-16 are top plan views of the card connector constructed in accordance with the present invention in the second embodiment during the UFS card's ejection.

### DETAILED DESCRIPTION OF THE PREFERRED EMBODIMENT

Reference will now be made in detail to the preferred embodiment of the present invention.

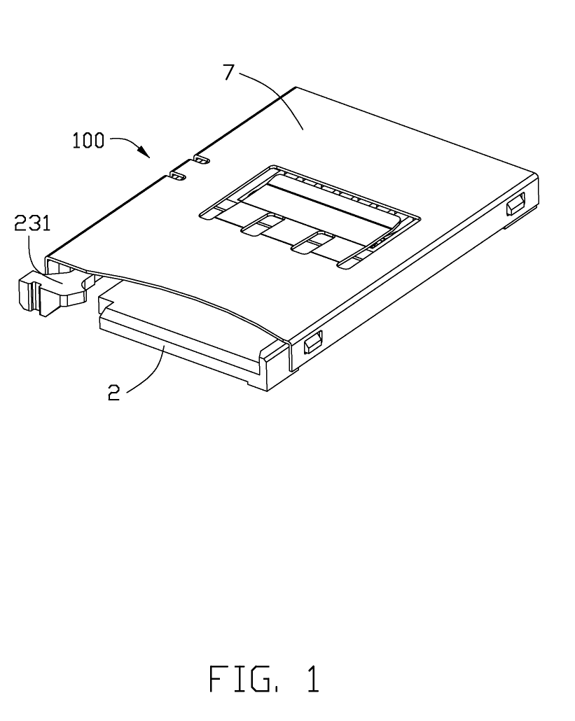

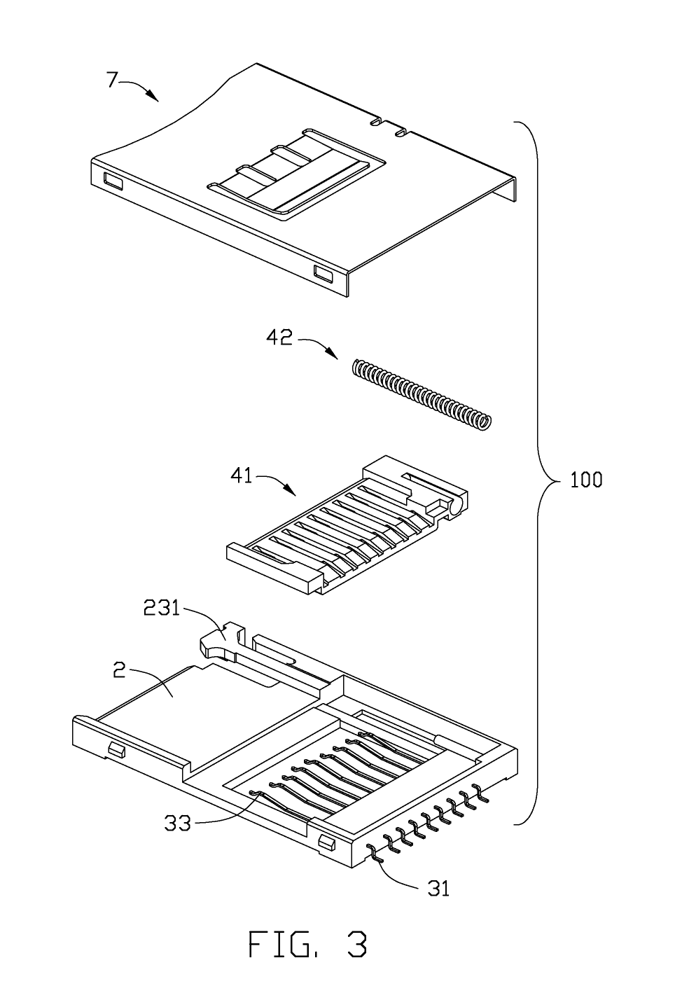

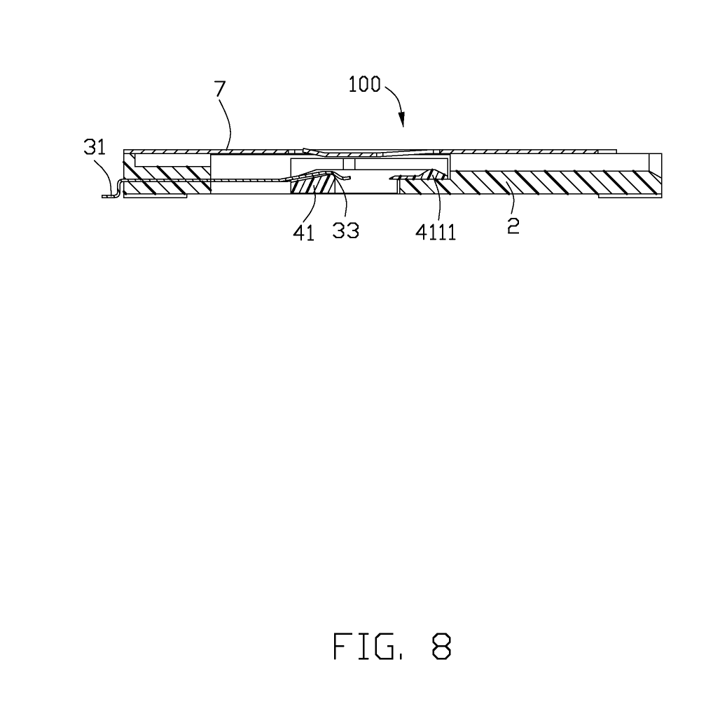

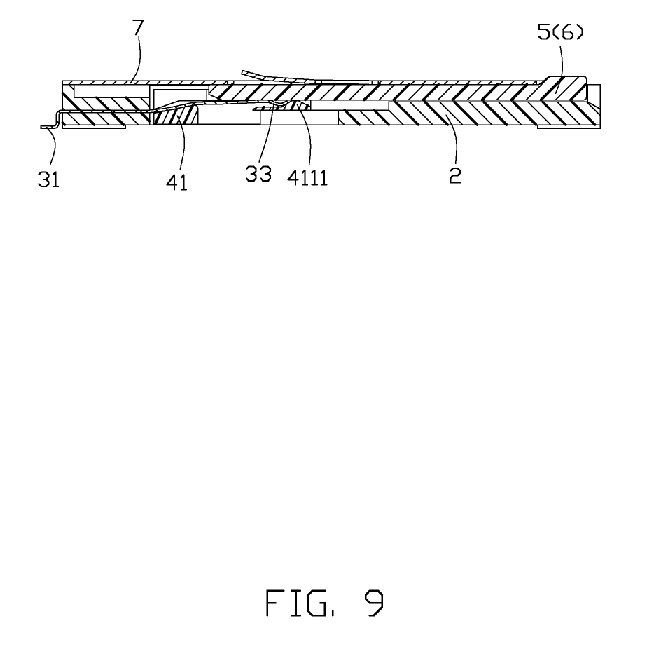

Referring to FIGS. 1-9, a card connector 100 in accordance with the present invention in a first embodiment used for alternatively receiving a UFS (Universal Flash Storage) card 5 and a micro SD (Secure Digital) card 6, comprises an insulative housing 2, a plurality of contacts 3 received in the insulative housing 2, a slider 41 assembled on the insulative housing 2 and movable relative to the insulative housing 2 along a card insertion/ejection direction, and a spring 42 sandwiched between the insulative housing 2 and the slider 41 for urging the slider 41 along the card ejection direction. The card connector 100 further comprises a metal shell 7 covering the insulative housing 2 for shielding.

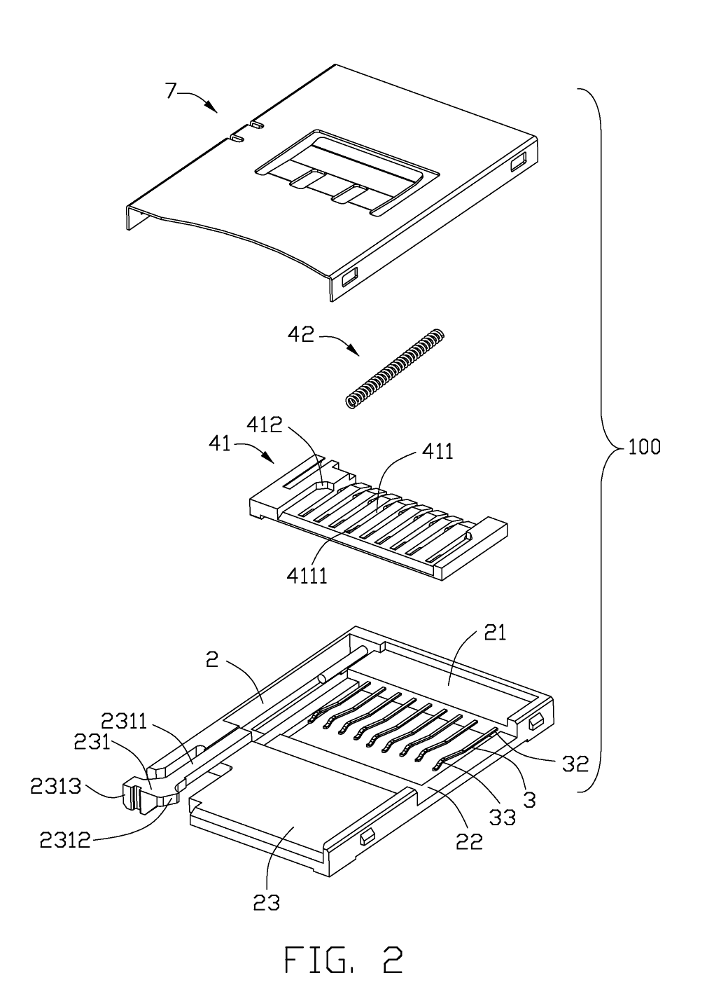

Referring to FIGS. 2, 3, 8, and 9, the insulative housing 2 comprises a front retaining portion 21, a middle supporting portion 22, and a rear securing portion 23 positioned along the card insertion/ejection direction. The contacts 3 have a plurality of soldering portions 31 extending out of the insulative housing 2, a plurality of connecting portions 32 retained in the retaining portion 21, and a plurality of contacting portions 33 extending rearward upwardly towards the supporting portion 22. The slider 41 is assembled on the supporting portion 22 and is movable forward on the insulative housing 2 such that the contacting portions 32 are raised up by the slider 41 for connecting with the UFS card 5 or the micro SD card 6. The insulative housing 2 forms a rear latch 231 at a lateral side of the securing portion 23. The rear latch 231 comprises a flexible arm 2311 integral with the insulative housing 2, a card lock 2312 inwardly formed at the free end of the flexible arm 2311, and an operating portion 2313 formed at the free end of the flexible arm 2311 which is opposite to the card lock 2312. The slider 41 and the insulative housing 2 together define a card receiving space (not labeled). The flexible arm 2311 abuts against the card receiving space and is deflectable away from the card receiving space when the card lock 2312 or the operating portion 2313 is pushed for giving away to the UFS card 5 or the micro SD card 6. The card lock 2312 protrudes towards the card receiving space and is capable of being secured with the UFS card 5 or the micro SD card 6.

Referring to FIGS. 2, 3, 8, and 9, the slider 41 is assembled on the supporting portion 22 and is movable on the insulative housing 2. The slider 41 defines a plurality of recesses 411 extending along the card insertion/ejection direction for receiving the contacting portions 33 of the contacts 3. The slider 41 forms a cam 4111 in each recess 411. The contacting portions 33 are raised upwardly into the card receiving space by the cams 4111 for connecting with the UFS card 5 or the micro SD card 6. The slider 41 comprises a confronting portion 412 at a front, left side thereof. The UFS card 5 or the micro SD card 6 confronts with the confronting portion 412 for pushing the slider 41 to move along the card insertion direction and the confronting portion 412 reversely pushes the UFS card 5 or the micro SD card 6 to move along the card ejection direction. During the movement of the slider 41 along the card insertion direction, the spring 42 is compressed to have elasticity. The elasticity of the spring 42 is released and therefore, the spring 42 urges the slider 41 to move along the card ejection direction.

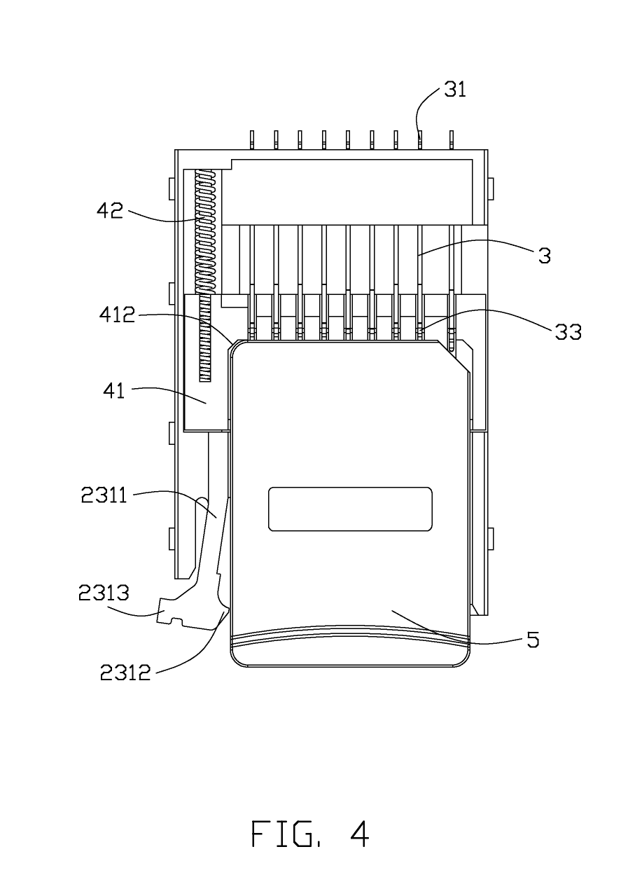

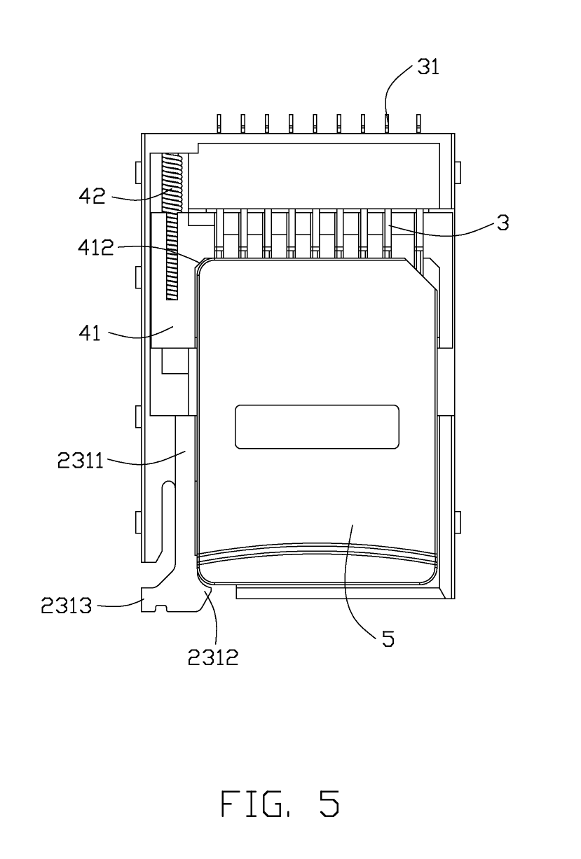

Referring to FIGS. 4 and 5, showing a process that the UFS card 5 is inserted into the card receiving space. The UFS card 5 begins to be inserted into the card receiving space, the front edge of the UFS card 5 pushes the card lock 2312 outwardly and the flexible arm 2311 is deflected away from the card receiving space for giving away for the UFS card 5. When the UFS card 5 is initially inserted as FIG. 4, the UFS card 5 confronts the confronting portion 412 of the slider 41 and begins to drive the slider 41 to move along the card insertion direction. The spring 42 becomes compressed and has elasticity. When the UFS card 5 is fully inserted as FIG. 5, the flexible arm 2311 returns back to its original position and the card lock 2312 is secured with the rear edge of the UFS card 5. The contacting portions 33 of the contacts 3 are raised upwardly for connecting with the UFS card 5. Since the UFS card 5 has a larger front width, the UFS card 5 electrically connects with nine contacting portions 33 of the contacts 3. When the UFS card 5 is ejected, a user pushed the operating portion 2313 outwardly by a finger and the flexible arm 2311 is deflected outwardly. The elasticity of the spring 42 is released for ejecting the UFS card 5.

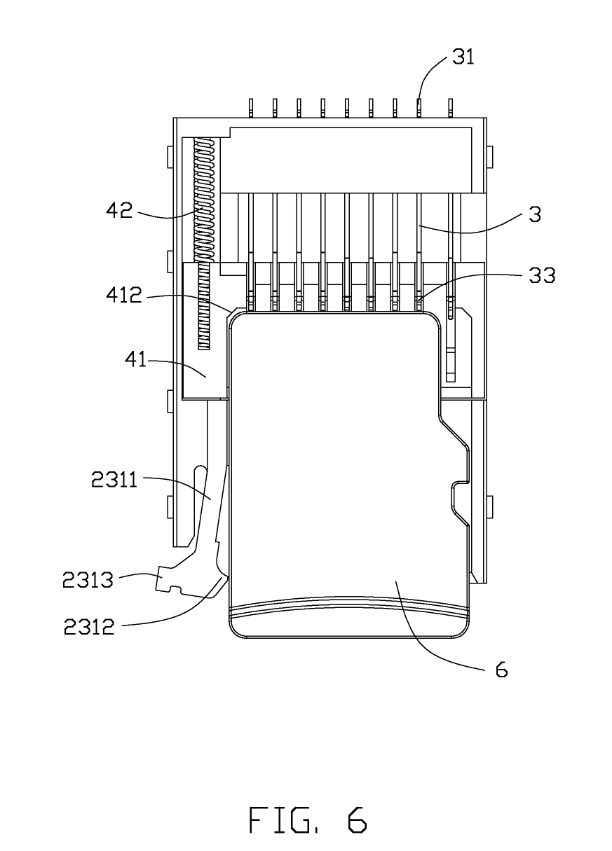

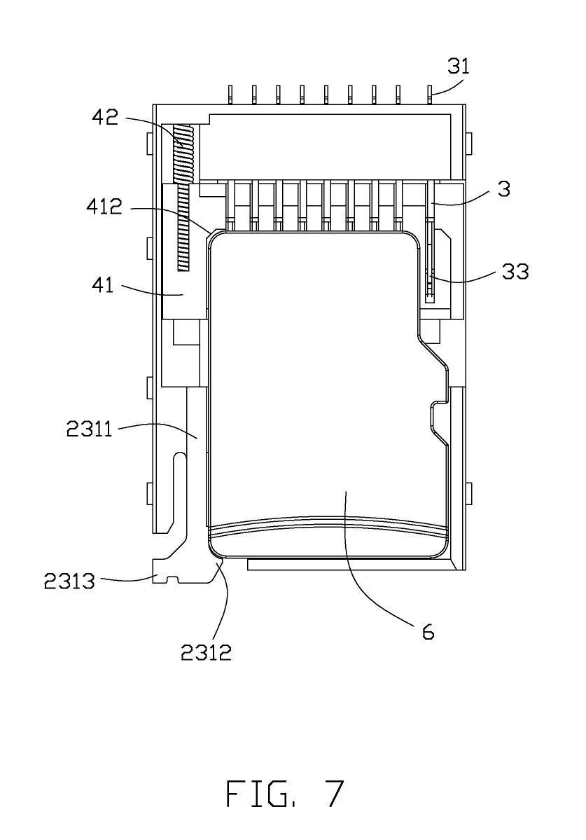

Referring to FIGS. 6 and 7, showing a process that the micro SD card 6 is inserted into the card receiving space. The micro SD card 6 begins to be inserted into the card receiving space, since the micro SD card 6 has a smaller front edge, the front edge of the micro SD card 6 does not push the card lock 2312 but the middle part of the micro SD card 6 pushes the card lock 2312 outwardly for instead, and therefore, the flexible arm 2311 is deflected by the micro SD card 6 away from the card receiving space for giving away for the micro SD card 6. When the micro SD card 6 is initially inserted as FIG. 6, the front edge of the micro SD card 6 confronts the confronting portion 412 of the slider 41 and drives the slider 41 to move along the card insertion direction. The spring 42 becomes compressed and has elasticity. The contacting portions 33 of the contacts 3 are raised upwardly for connecting with the micro SD card 6. When the micro SD card 6 is fully inserted as FIG. 7, the flexible arm 2311 returns back to its original position and the card lock 2312 is secured with the rear edge of the micro SD card 6. The micro SD card 6 electrically connects with eight contacting portions 33 of the contacts 3, namely the right, ninth contacting portion 33 is not in use. When the micro SD card 6 is ejected, a user pushed the operating portion 2313 outwardly by a finger and the flexible arm 2311 is deflected outwardly. The elasticity of the spring 42 is released for ejecting the micro SD card 6.

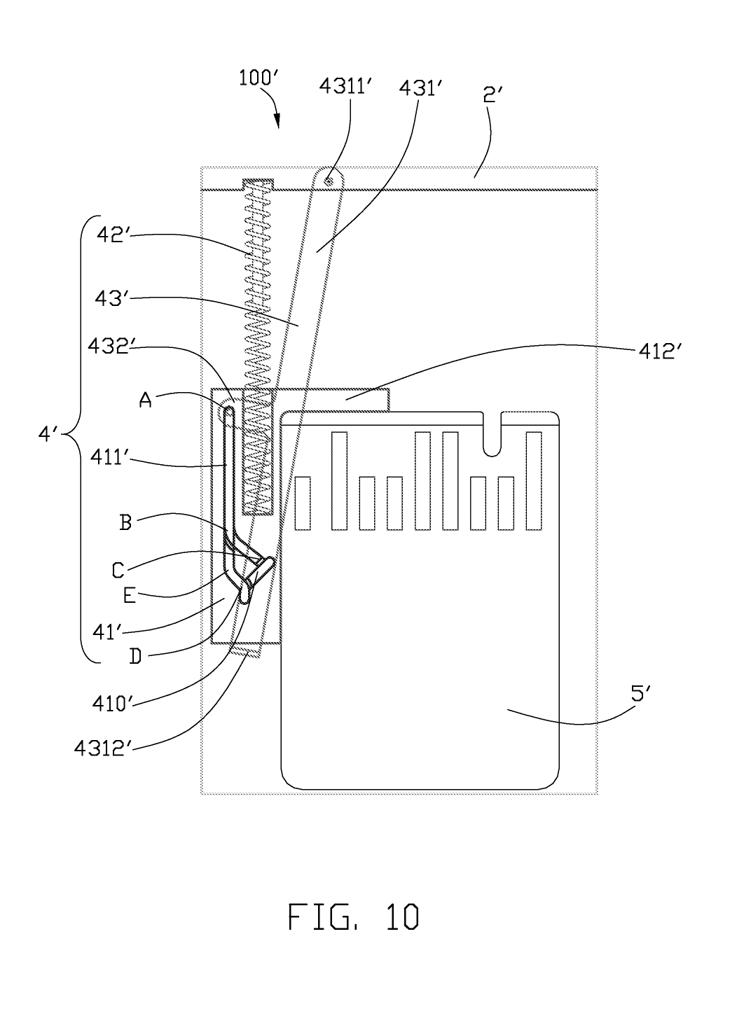

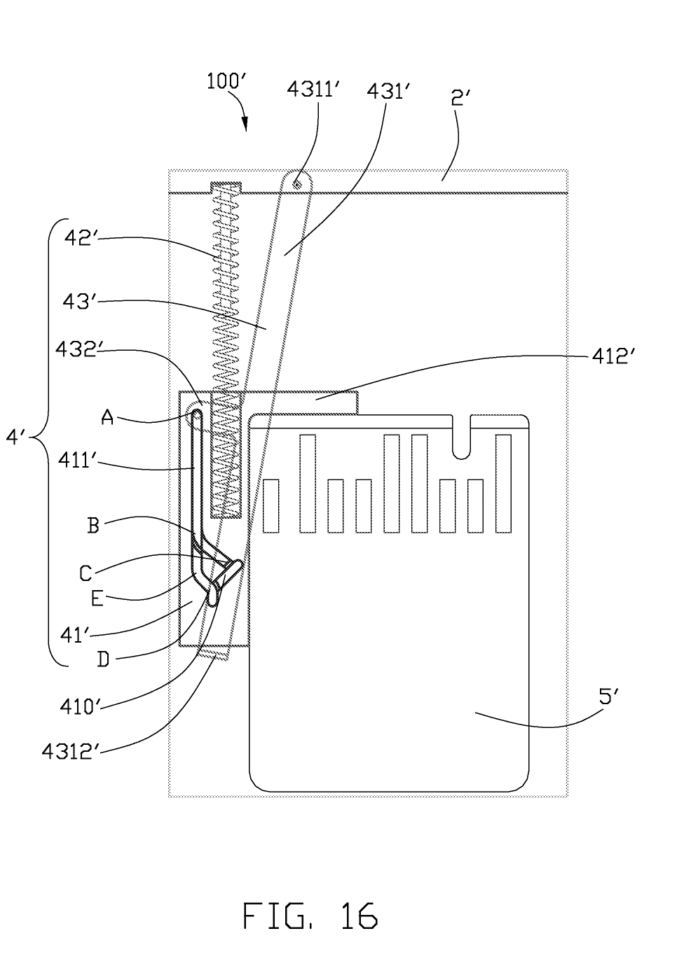

Referring to FIGS. 10-16, a push-push card connector 100′ in accordance with the present invention in a second embodiment defines a card receiving space (not labeled) for receiving the UFS card 5′. Card insertion/ejection direction is defined thereby. The push-push card connector 100′ comprises an insulative housing 2′, a plurality of contacts (not shown) retained in the insulative housing 2′, and an ejector 4′ assembled at the lateral side of the insulative housing 2′. The ejector 4′ comprises a slider 41′ defining a heart-shaped slot 410′, a spring 42′ urging the slider 41′ in the card ejection direction, and a rear latch 43′ moveable relative to the slider 41′. The slider 41′ comprises a lengthwise portion 411′ and a transverse portion 412′ perpendicular to the lengthwise portion 411′. The heart-shaped slot 410′ is defined on the lengthwise portion 411. The transverse portion 412′ extends laterally from the lengthwise portion 411′ into the card receiving space. The spring 42′ is compressed between the insulative housing 2′ and the lengthwise portion 411′. The rear latch 43′ has a main portion 431′ and a guiding portion 432′ forked with the main portion 431′. The main portion 431′ has a fixed end 4311′ pivotally assembled to a front part of the insulative housing 2′ and a free end/card lock 4312′ extending beyond a rear edge of the slider 41′. The guiding portion 432′ is moveable guided in the heart-shaped slot 410′.

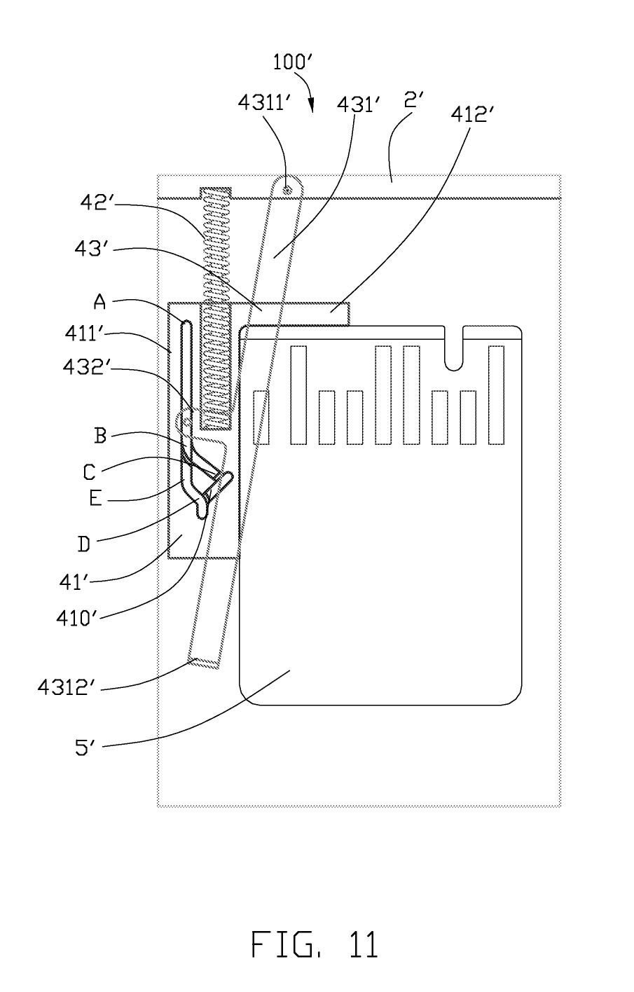

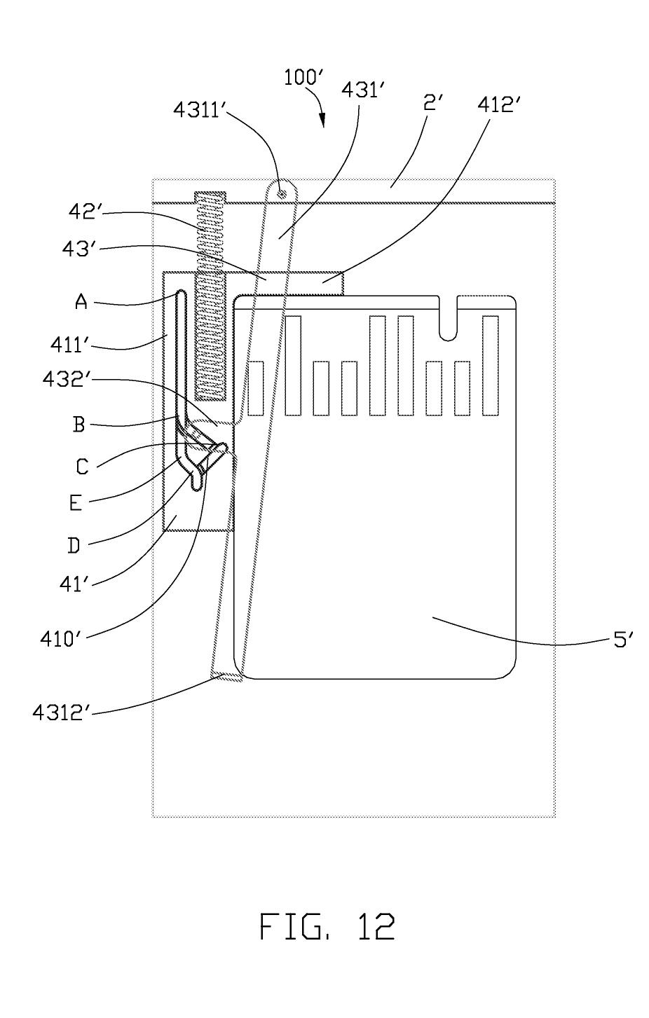

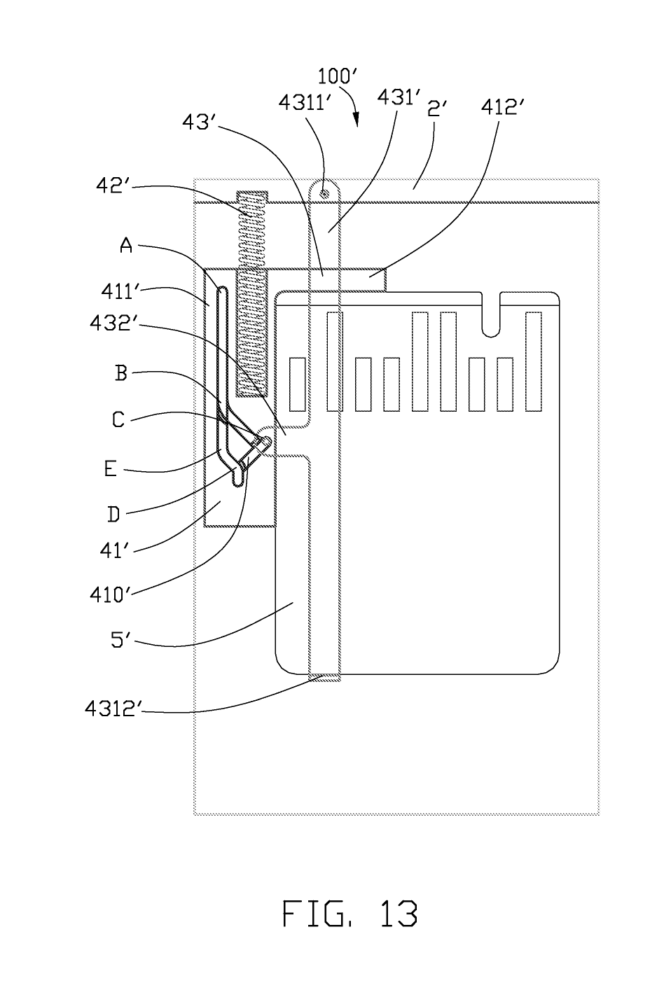

FIGS. 10-13 are top plan views of the card connector 100′ during the UFS card's insertion. Referring to FIG. 10, when the UFS card 5′ is initially inserted into the card receiving space, the UFS card 5′ gets to the transverse portion 412′ of the slider 41′ without obstacle. A user pushes the UFS card 5′ and the slider 41′ is movable together with the UFS card 5′ along the card insertion direction. The spring 42′ extends naturally along the card insertion/ejection direction. The guiding portion 432′ is positioned at the A point, which is the frontal position of the heart-shaped slot 410′. The main portion 431′ obliquely extends across the slider 41′ such that the free end/card lock 4312′ extending beyond the slider 41′ without interference. Referring to FIG. 11, the UFS card 5′ is inserted deeper into the card receiving space. The spring 42′ becomes compressed and has elasticity. The guiding portion 432′ moves away from the A point towards the B point. The main portion 431′ still obliquely extends across the slider 41′ with the free end/card lock 4312′ moving rightward and farther away from the slider 41′ but not attaching the rear edge of the UFS card 5′. Referring to FIG. 12, the free end/card lock 4312′ achieves the rear edge of the UFS card 5′. The spring 42′ is further compressed. The guiding portion 432′ moves rightward and rearward from the B point towards the C point. In FIG. 13, when the guiding portion 432′ is finally positioned at the C point which is nearest to the card receiving space, the UFS card 5′ is orientated at the inner position at which the UFS card 5′ is fully inserted and electrically connected with the contacts. The main portion 431′ extends along the card's insertion/ejection direction and the free end/card lock 4312′ finally secures with the rear edge of the UFS card 5′. The UFS card 5′ is fixedly received in the card receiving space and is prevented from dropping out of the card receiving space.

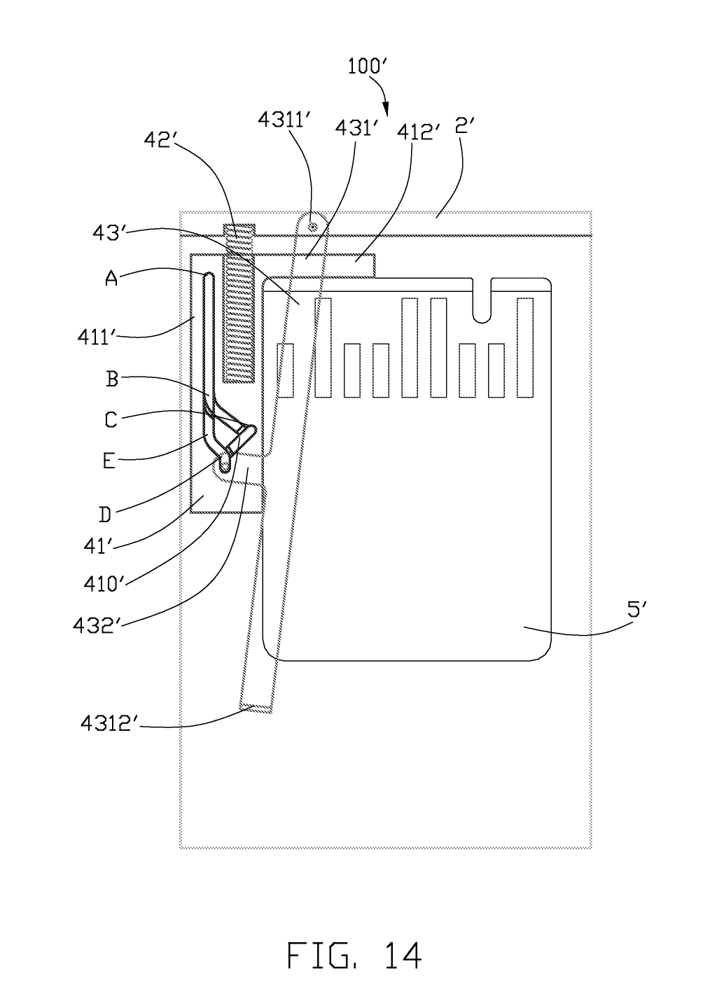

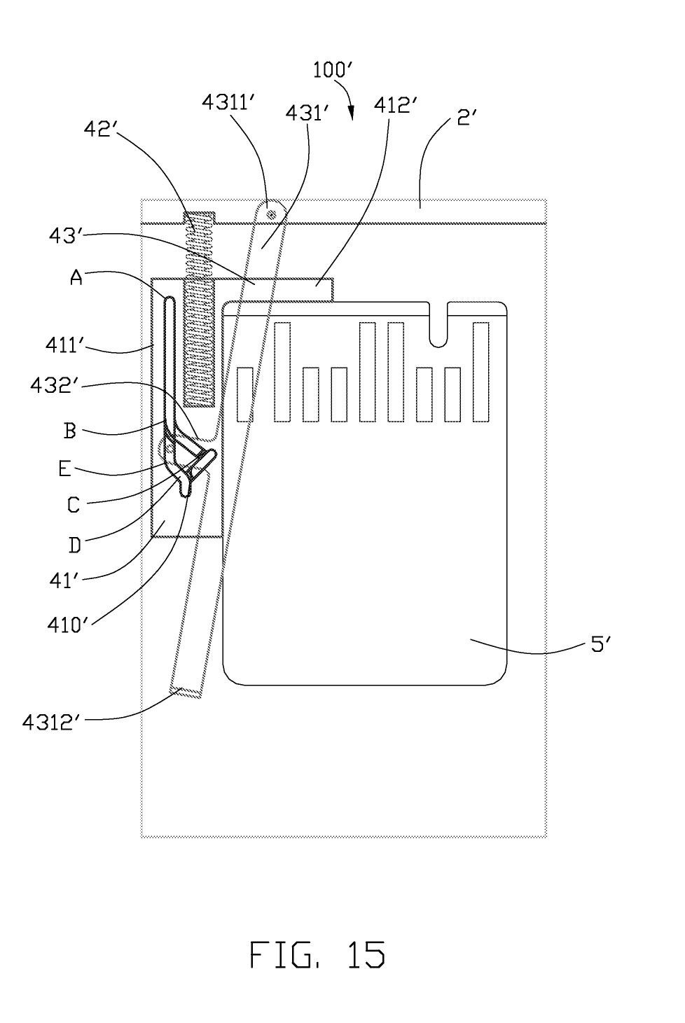

FIGS. 14-16 are top plan views of the card connector 100′ during the UFS card's ejection. In order to push the UFS card 5′ out of the card connector 100′, a user pushes the UFS card 5′ along the card's insertion direction again and then the finger moves away. Referring to FIG. 14, the spring 42′ is compressed greater than it is at the inner position. The guiding portion 432′ moves leftward and rearward from the C point towards the D point and therefore, the main portion 431′ returns to oblique performance and unlocks with the rear edge of the UFS card 5′. The guiding portion 432′ does not stay at the D point but moves leftward and frontward across the E point and finally moves back to the A point, referring to FIGS. 14 and 15, during which the UFS card 5′ is finally ejected out of the card connector 100′.

The rear latch 231/43′ secures with rear edge of the inserted card 5/6/5′ and prevents the card 5/6/5′ from dropping out of the card receiving space. The card lock 2312 of the rear latch 231 is deflectable laterally or the card lock 4312′ of the rear latch 43′ is moveable sideward both for giving place to the inserted card 5/6/5′. The card lock 2312/4312′ of the rear latch 231/43′ substantially secures with a rear edge of the card receiving space when card 5/6/5′ is fixedly received in the card receiving space.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A card connector comprising:
an insulative housing;
a plurality of contacts retained in the insulative housing;
a slider assembled on the insulative housing and movable relative to the insulative housing;
a spring compressed between the insulative housing and the slider for urging the slider along a card ejection direction; and
a rear latch having a card lock extending to a rear edge of an inserted card for securing with the rear edge of the inserted card.

2. The card connector as claimed in claim 1, wherein the rear latch comprises a flexible arm integral with the insulative housing and the card lock is formed at the free end of the flexible arm.

3. The card connector as claimed in claim 2, wherein the slider and the insulative housing together define a card receiving space and the flexible arm is deflectable away from the card receiving space.

4. The card connector as claimed in claim 3, wherein the card lock protrudes towards the card receiving space and the rear latch comprises an operating portion formed at the free end of the flexible arm opposite to the card lock.

5. The card connector as claimed in claim 4, wherein the contacts are raised up into the card receiving space during a movement of the slider along a card insertion direction.

6. The card connector as claimed in claim 4, wherein the inserted card is either a UFS card or a micro SD card.

7. The card connector as claimed in claim 4, wherein the slider comprises a confronting portion which the inserted card confronts with for pushing the slider along the card insertion direction and for the slider to push the inserted card out of the card receiving space along the card ejection direction.

8. The card connector as claimed in claim 4, wherein the card lock is pushed by a front edge of the inserted card outwardly at the beginning of the insertion of the card.

9. The card connector as claimed in claim 4, wherein the card lock is pushed by a middle part of the inserted card during the insertion of the card.

10. The card connector as claimed in claim 1, wherein the rear latch is assembled on the insulative housing.

11. The card connector as claimed in claim 10, wherein the rear latch has a main portion and a guiding portion forked with the main portion.

12. The card connector as claimed in claim 11, wherein the main portion has a fixed end pivotally assembled to a front part of the insulative housing and the card lock comprises a free end opposite to the fixed end and extending beyond a rear edge of the slider.

13. The card connector as claimed in claim 12, wherein the slider defines a heart-shaped slot and the guiding portion is guided in the heart-shaped slot.

14. The card connector as claimed in claim 13, wherein the insulative housing defines a card receiving space and the guiding portion is positioned nearest to the card receiving space in the heart-shaped slot when the card is fully inserted.

15. A card connector assembly for use with an electronic card, comprising:
an insulative housing defining a card receiving space communicating with an exterior via a front opening for receiving the electronic card;
a plurality of contacts disposed in the housing with contacting sections;
a slider back and forth movable with regard to the housing along a front-to-back direction via a spring, said slider defining a confronting portion for confrontation with a front edge of the electronic card so as to be able to move along with the electronic card during insertion/ejection of the electronic card; and
a moveable latch defining a latch section around said front opening for locking a rear edge of the electronic card.

16. The card connector assembly as claimed in claim 16, wherein the slider defines a plurality of recesses to receive the corresponding contacts, respectively.

17. The card connector assembly as claimed in claim 15, wherein said slider is equipped with cam structures to raise up the contacting sections of the corresponding contacts when said slider is moved from a front position to a rear position.

18. The card connector assembly as claimed in claim 17, wherein when the slider is located at the front position, the latch section no longer locks the rear edge of the electronic card.

19. The card connector assembly as claimed in claim 15, wherein the latch is pivotal with regard to the housing to have the latch section to be moveable.

20. The card connector assembly as claimed 19, wherein a guiding structure is formed on the latch and the slider to have the latch move corresponding to movement of the slider, and includes a heart like groove cooperating with a pin moving along the groove.
